(19) United States
(12) Patent Application Publication
(10) Pub. No.: US 2010/0165313 A1
(43) Pub. Date: Jul. 1, 2010

(54) MIRROR SUBSTRATE, MIRROR, EXPOSURE APPARATUS, DEVICE MANUFACTURING METHOD, AND MIRROR MANUFACTURING METHOD

(75) Inventors: Ryo Nawata, Utsunomiya-shi (JP); Toru Matsuda, Utsunomiya-shi (JP); Toshinori Furusawa, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/634,451

(22) Filed: Dec. 9, 2009

(30) Foreign Application Priority Data
Dec. 25, 2008 (JP) 2008-330367

(51) Int. Cl. G03B 27/70; G02B 5/10; B05D 5/06

(52) U.S. Cl. 355/66; 359/868; 359/359; 355/77; 427/162

(57) ABSTRACT

In a light-transmitting mirror substrate having an axisymmetrical aspherical surface, a surface of the mirror substrate on a side opposite to the axisymmetrical aspherical surface is inclined with respect to an axis of symmetry of the axisymmetrical aspherical surface.

### BACKGROUND OF THE INVENTION

1. Field of the Invention

The present invention relates to a mirror substrate. The mirror substrate is suitable as an element of a precision apparatus such as an exposure apparatus used in a lithography step of a semiconductor device manufacturing process.

2. Description of the Related Art

A reduction projection exposure apparatus is used for manufacturing semiconductor devices having a fine circuit pattern, such as semiconductor memories and logic circuits, using a photolithography technique. In a reduction projection exposure apparatus, a circuit pattern on a reticle (or a mask) is projected onto a body to be processed, such as a wafer, by a projection optical system, and the circuit pattern is transferred.

The minimum critical dimension that can be transferred by a reduction projection exposure apparatus (resolution) is proportional to the wavelength of light used for exposure and is inversely proportional to the numerical aperture (NA) of the projection optical system. Therefore, the resolution increases with decreasing wavelength. Along with increased fineness of semiconductor devices, the wavelength of exposure light is being shortened. For example, a high-pressure mercury lamp (i-line (365 nm)), a KrF excimer laser (248 nm), and an ArF excimer laser (193 nm) are used as ultraviolet light sources.

However, the fineness of semiconductor devices is rapidly increasing, and the lithography using ultraviolet light has limitations. Therefore, in order to efficiently transfer very fine circuit patterns below 0.1 μm, a reduction projection exposure apparatus that uses extreme ultraviolet (EUV) light having wavelengths shorter than the wavelengths of ultraviolet light, about 10 to 15 nm (hereinafter referred to as “EUV exposure apparatus”) has been developed.

To achieve high resolution exposure, it is important to form the surface shapes of mirrors constituting a projection optical system with a high degree of accuracy or precision.

A mirror is manufactured by forming a mirror substrate of ultralow thermal expansion glass into a desired shape and thereafter forming a reflective film on a surface of the glass substrate serving as a mirror surface. To form a mirror substrate into a desired shape, first, a mirror shape is formed in the mirror substrate, thereafter the shape of a surface serving as a mirror surface is measured with a high degree of accuracy or precision, and the surface serving as a mirror surface is modified on the basis of the measurement result. Thus, the surface serving as a mirror surface can be formed with a high degree of accuracy or precision.

The shape of the mirror surface of a mirror for an exposure apparatus is an axisymmetrical aspherical surface. The axisymmetrical aspherical surface is measured using an aspherical surface shape measuring device. Aspherical surface shape measuring devices include a so-called Fizeau interferometer. A surface shape measuring method using an aspherical surface shape measuring device is disclosed in U.S. Pat. No. 6,781,700.

A brief description will be given of a surface shape measuring method in an aspherical surface shape measuring device. FIG. 1 shows the schematic configuration of an aspherical surface shape measuring device. The aspherical surface shape measuring device has a quasi-monochromatic light source S. Light S0 emitted from the light source S is condensed by a lens L1 to a pinhole PH. After passing through the pinhole, the light diverges, passes through a beam splitter BS, and is collimated by a collimator lens CL1. The collimated light is converged by a condenser lens CL2 and enters a reference spherical wave generating lens TS. Hereinafter, the optical axis of the lens TS will be denoted as OA, and the z direction is parallel to the optical axis.

The lens TS reflects part of the light S0 with a surface TS1 thereof on the side opposite to the light source S. The light reflected by the surface TS1 will be referred to as reflected light RS0. The reflected light RS0 serves as a reference wavefront, and therefore the lens TS is also referred to as reference wavefront generating lens. The reflected light RS0 passes through the lenses CL2 and CL1, is reflected by the beam splitter BS, passes through a lens L2, and thereafter reaches an image pickup device C.

On the other hand, the light S1 passing through the lens TS is condensed at the condensing position CP, thereafter becomes diverging light, and falls on an object T to be inspected. The light S1 is reflected by a surface T1 to be inspected. The reflected light will be referred to as reflected light RS1. The reflected light RS1 is condensed at the condensing position CP, passes through the lenses TS, CL2, and CL1, is reflected by the beam splitter BS, passes through the lens L2, and thereafter reaches the image pickup device C. The reflected light RS0 reflected by the lens TS and the reflected light RS1 reflected by the surface T1 to be inspected interfere with each other and therefore generate interference fringes on the image pickup device C. A CCD sensor is usually used as the image pickup device C. The object T to be inspected can be moved in the Z-axis direction.

When the surface T1 to be inspected is an axisymmetrical aspherical surface and the curvature radius on the optical axis is R0, and when the distance Z between the condensing position CP of the lens TS and the surface T1 to be inspected is equal to the central curvature radius R0 of the surface T1 to be inspected, low-density interference fringes are generated in the center as shown in FIG. 2A.

If the object T to be inspected is moved in the Z-axis direction by V and the distance Z between the condensing position CP of the lens TS and the surface T1 to be inspected becomes R0+V, low-density interference fringes are generated in the center and annularly as shown in FIG. 2B. The annular low-density interference fringes show a place where the curvature radius of the surface T1 to be inspected is equal to R0+V, that is, a part where the light S1 is perpendicularly reflected by the surface T1 to be inspected. An aspherical surface shape measuring device measures the surface shape of the surface T1 to be inspected, by measuring the low-density interference fringes in the center and the annular low-density interference fringes.

Hereinafter, a problem newly found by the inventor of this application and to be solved with respect to the prior art of the surface shape measurement will be described with reference to drawings. If the object T to be inspected is a highly transmissive material such as glass, as shown in FIG. 3, part of the light S1 passes through the surface T1 to be inspected, reaches the back surface T2 of the object T to be inspected, and is reflected by the back surface T2.

FIGS. 4A, 4B, 5A, and 5B show the reflection by a surface on the side opposite to the surface T1 to be inspected. FIGS. 4A and 5A show a case where the surface T1 to be inspected is a concave surface. FIGS. 4B and 5B show a case where the surface T1 to be inspected is a convex surface.

As shown in FIGS. 4A and 4B, part of the light S1 of the aspherical surface shape measuring device that does not travel on the optical axis OA, or the light S1T is reflected by the back surface T2 and becomes reflected light RS2T. The reflected light RS2T does not travel on the optical axis OA and therefore does not interfere with the reflected light RS0 reflected by the lens TS.

However, as shown in FIGS. 5A and 5B, part of the light S1 of the aspherical surface shape measuring device that travels on the optical axis OA, or the light S1OA is reflected at a point where the optical axis OA intersects the back surface T2 (hereinafter referred to as point P) and becomes reflected light RS2OA. The reflected light RS2OA travels on the optical axis OA and interferes with the reflected light RS0 reflected by the lens TS. The reflected light RS2OA generates interference fringes called ghost in the central part of the interference fringes and can reduce the accuracy or precision of the surface shape measurement. Therefore, part of the light S1 that travels on the optical axis OA, or the light S1OA must be prevented from being perpendicularly reflected by the back surface T2, becoming reflected light RS2OA, and returning to the optical axis OA.

In the measurement of the surface shape of a lens for an exposure apparatus, an antireflection agent G such as paint or gel is applied around the point P as shown in FIG. 6 to prevent the incident light S1OA on the optical axis OA from being reflected by the back surface T2 and returning to the optical axis OA. Most of the antireflection agent G applied to the lens is removed after the surface shape measurement, but a very small amount of the antireflection agent G remains on the lens. In an EUV exposure apparatus, substances (such as degassed gas) released from the residual antireflection agent G reacts chemically with EUV light, adheres to the mirror surface, and deteriorates the exposure performance. Therefore, an antireflection agent G cannot be applied to a mirror for an EUV exposure apparatus.

In a case where a film is formed on the surface T1 to be inspected after the surface shape measurement and the object T to be inspected becomes a mirror, the back surface T2 can be processed for antireflection. In FIG. 7, to scatter (diffuse) the reflected light RS2OA at the point P, a portion W around the point P is roughened. However, ghost due to the reflected light RS2OA at the point P cannot be sufficiently prevented just by roughening the portion W around the point P. In addition, in a vacuum apparatus such as an EUV exposure apparatus, roughening the portion W around the point P leads to the generation of degassed gas (degassing) from the portion and may degrade the degree of vacuum.

### SUMMARY OF THE INVENTION

The present invention provides, for example, a mirror substrate advantageous in degassing amount reduction and surface shape accuracy.

In an aspect of the present invention, a light-transmitting mirror substrate includes an axisymmetrical aspherical surface. A surface of the mirror substrate on a side opposite to the axisymmetrical aspherical surface is inclined with respect to an axis of symmetry of the axisymmetrical aspherical surface. In another aspect of the present invention, a light-transmitting mirror substrate includes an axisymmetrical aspherical surface. A normal to the surface of the mirror substrate on the side opposite to the axisymmetrical aspherical surface, the normal extending from a point of intersection of the surface of the mirror substrate on the side opposite to the axisymmetrical aspherical surface and the axis of symmetry of the axisymmetrical aspherical surface, is inclined with respect to the axis of symmetry of the axisymmetrical aspherical surface. More succinctly, the surface of the mirror substrate on the side opposite to the axisymmetrical aspherical surface is inclined at the axis of symmetry of the axisymmetrical aspherical surface with respect to the axis of symmetry of the axisymmetrical aspherical surface.

Further features of the present invention will become apparent from the following description of exemplary embodiments with reference to the attached drawings.

### BRIEF DESCRIPTION OF THE DRAWINGS

FIG. 1 illustrates an aspherical surface shape measuring device.

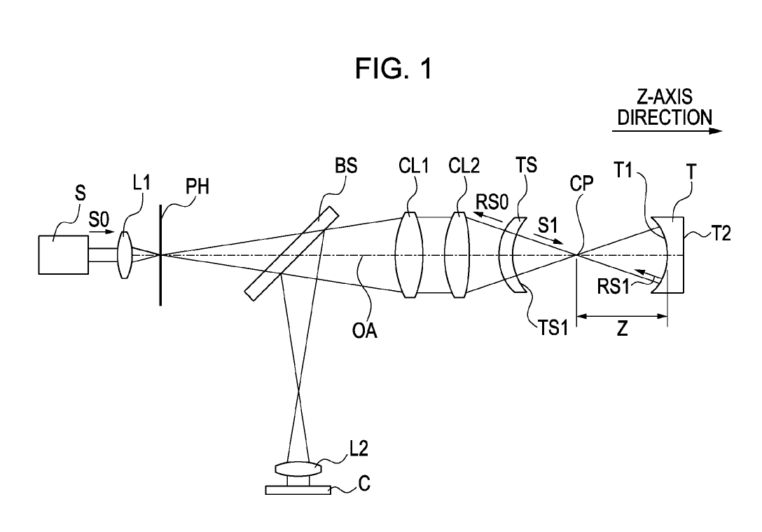

FIGS. 2A and 2B show interference fringes observed when an axisymmetrical aspherical surface is measured with an aspherical surface shape measuring device.

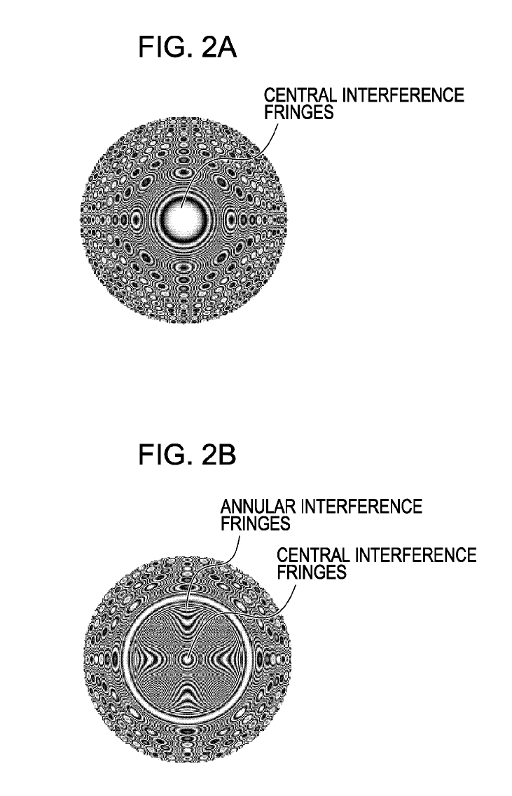

FIG. 3 shows light reflected by an object to be inspected.

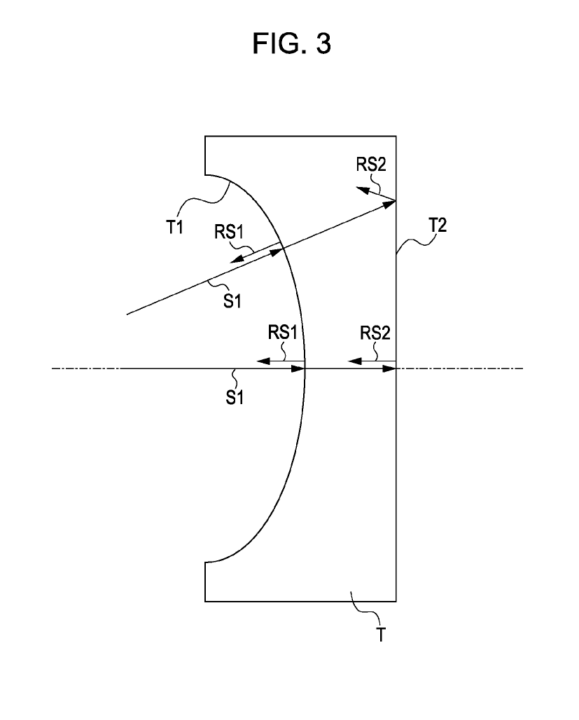

FIGS. 4A and 4B show reflection of light that does not travel on the optical axis of a surface to be inspected, at the back surface.

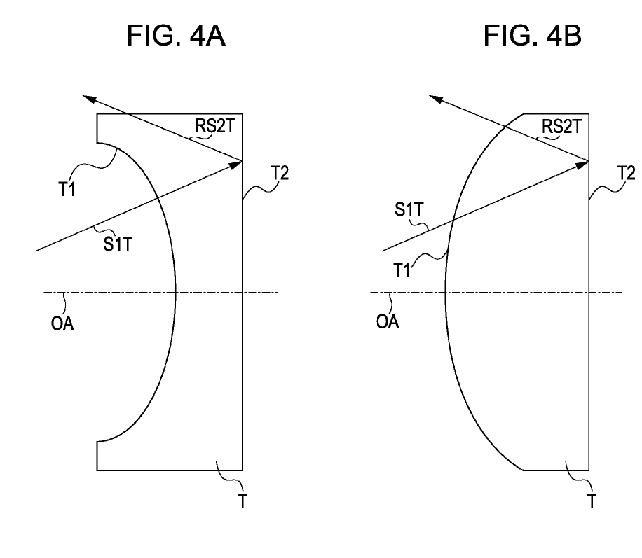

FIGS. 5A and 5B show reflection of light that travels on the optical axis of a surface to be inspected, at the back surface.

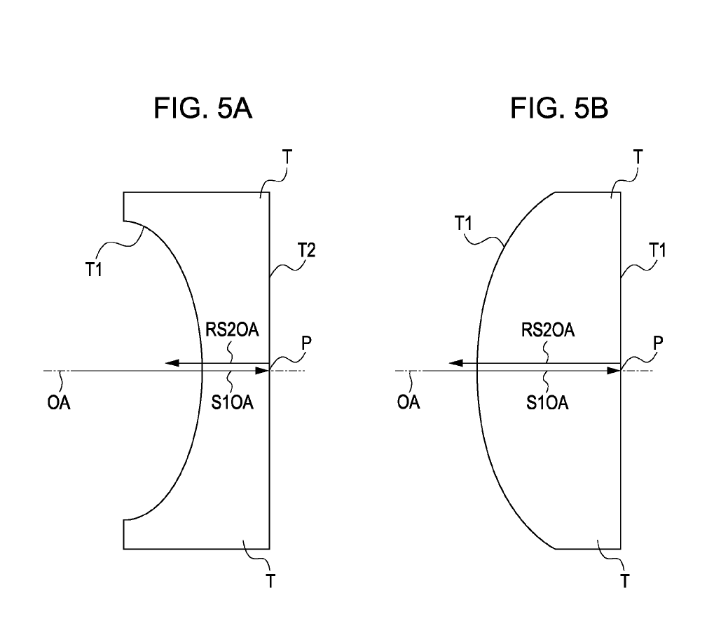

FIG. 6 shows an example of an object to be inspected (a lens) to which an antireflection agent is applied.

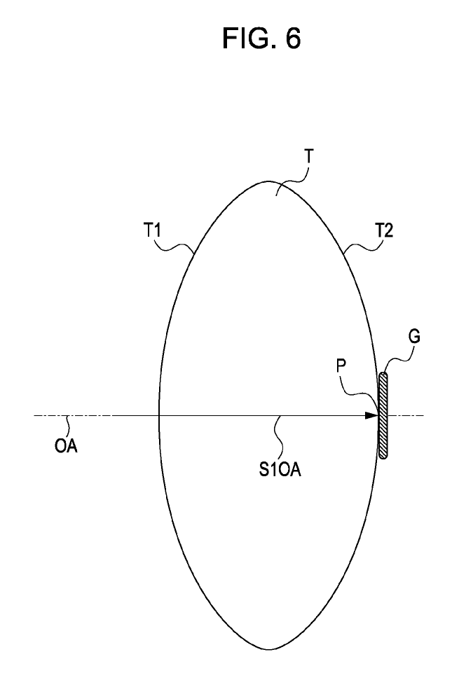

FIG. 7 shows an example of an object to be inspected the back surface of which is roughened.

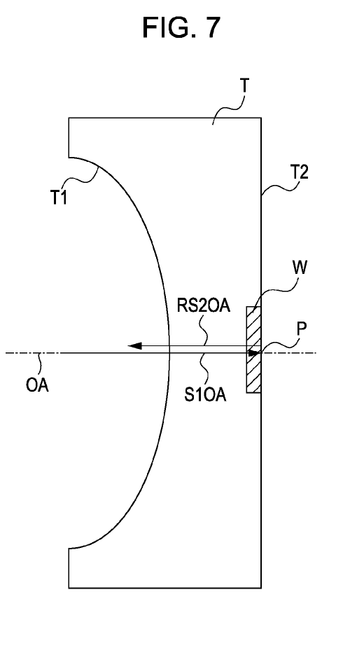

FIG. 8 illustrates an example of a concave mirror the entire back surface of which is inclined.

FIG. 9 illustrates an example of a convex mirror the entire back surface of which is inclined.

FIG. 10 illustrates an example of a concave mirror having an inclined portion formed in the back surface.

FIG. 11 illustrates an example of a convex mirror having an inclined portion formed in the back surface.

FIG. 12 illustrates an example of a concave mirror having a concave portion formed in the back surface.

FIG. 13 shows reflection at the concave portion formed in the back surface of the concave mirror.

FIG. 14 illustrates an example of a convex mirror having a concave portion formed in the back surface.

FIG. 15 shows reflection at the concave portion formed in the back surface of the convex mirror.

FIG. 16 illustrates a method of manufacturing a mirror.

FIG. 17 illustrates an example configuration of an exposure apparatus.

### DESCRIPTION OF THE EMBODIMENTS

The embodiments of the present invention will now be described in detail with reference to the drawings.

### First Embodiment

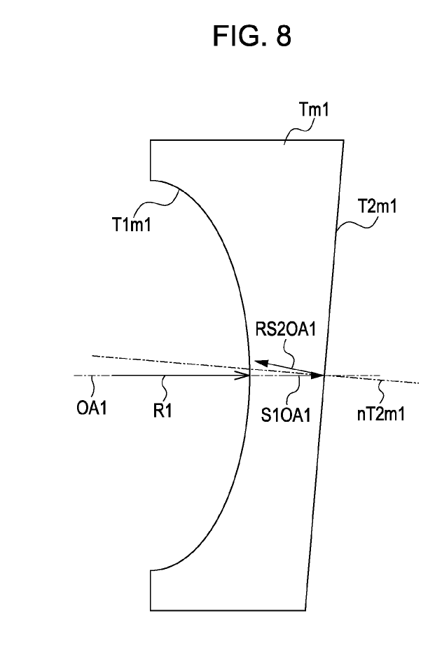

FIG. 8 shows the shape of a concave mirror Tm1 (a light-transmitting mirror substrate) used in an exposure apparatus. OA1 denotes the optical axis of an axisymmetrical aspherical surface T1m1, and the curvature radius on the optical axis OA1 is R1. The normal nT2m1 to a back surface T2m1 (a surface on the side opposite to the axisymmetrical aspherical surface T1m1) is inclined at a minute angle with respect to the optical axis (the axis of symmetry) OA1 of the axisymmetrical aspherical surface. That is, a normal to the surface on the side opposite to the axisymmetrical aspherical surface, the normal extending from a point of intersection of the surface on the side opposite to the axisymmetrical aspherical surface and the axis of symmetry of the axisymmetrical aspherical surface, is inclined with respect to the axis of symmetry of the axisymmetrical aspherical surface. More succinctly, the surface on the side opposite to the axisymmetrical aspherical surface is inclined (at the axis of symmetry of the axisymmetrical aspherical surface) with respect to the axis of symmetry of the axisymmetrical aspherical surface. In addition, the opposite surface forms a plane in a part including a point at the intersection with the axis of symmetry of the axisymmetrical aspherical surface. In the aspherical surface shape measurement, incident light S1OA1 on the optical axis OA1 is deflected by the back surface T2m1, and therefore the reflected light RS2OA1 is prevented from returning to the optical axis OA1. Therefore, the surface shape of the axisymmetrical aspherical surface T1m1 can be measured with a high degree of accuracy or precision. However, in the aspherical surface shape measurement, the optical axis OA of the lens TS and the optical axis OA1 of the axisymmetrical aspherical surface T1m1 to be inspected are positioned so as to correspond with each other.

### Second Embodiment

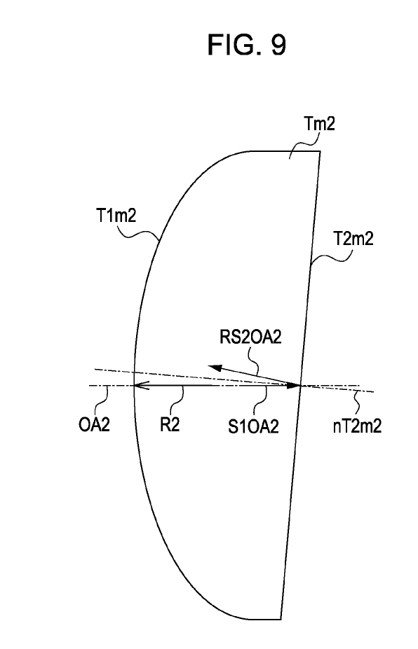

FIG. 9 shows the shape of a convex mirror Tm2 (a light-transmitting mirror substrate) used in an exposure apparatus. OA2 denotes the optical axis of an axisymmetrical aspherical surface T1m2, and the curvature radius on the optical axis OA2 is R2. The normal nT2m2 to a back surface T2m2 (a surface on the side opposite to the axisymmetrical aspherical surface T1m2) is inclined at a minute angle with respect to the optical axis (the axis of symmetry) OA2 of the axisymmetrical aspherical surface. That is, the surface on the side opposite to the axisymmetrical aspherical surface is inclined at the axis of symmetry of the axisymmetrical aspherical surface with respect to the axis of symmetry of the axisymmetrical aspherical surface. In addition, the opposite surface forms a plane in a part including a point at the intersection with the axis of symmetry of the axisymmetrical aspherical surface. In the aspherical surface shape measurement, incident light S1OA2 on the optical axis OA2 is deflected by the back surface T2m2, and therefore the reflected light RS2OA2 is prevented from returning to the optical axis OA2. Therefore, the aspherical surface shape of the axisymmetrical aspherical surface T1m2 can be measured with a high degree of accuracy or precision. However, in the aspherical surface shape measurement, the optical axis OA of the lens TS and the optical axis OA2 of the axisymmetrical aspherical surface T1m2 to be inspected are positioned so as to correspond with each other.

### Third Embodiment

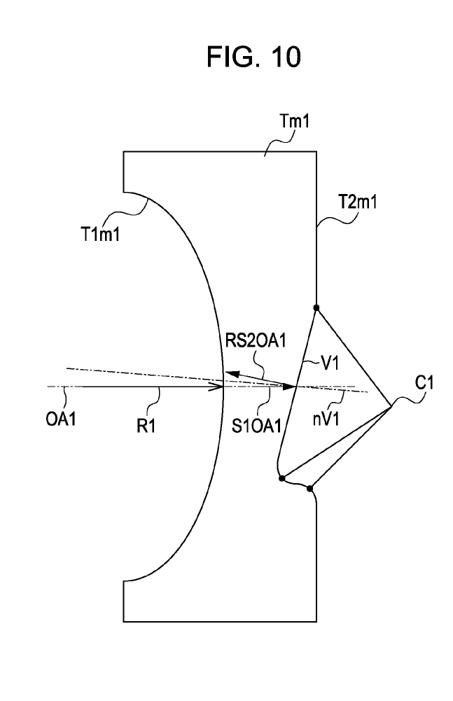

In the first embodiment, the entire back surface of the concave mirror Tm1 (light-transmitting mirror substrate) is inclined. However, in manufacturing a mirror, it can be difficult to incline the back surface T2m1 sufficiently to deflect the reflected light RS2OA1. In the measurement with an aspherical surface shape measuring device, the reflection by the back surface T2m1 on the optical axis OA1 of the axisymmetrical aspherical surface T1m1 is particularly problematical. In a third embodiment, as shown in FIG. 10, a portion V1 of the back surface T2m1 of the concave mirror Tm1 around the intersection with the optical axis OA1 is inclined.

FIG. 10 shows the shape of a concave mirror Tm1 used in an exposure apparatus. OA1 denotes the optical axis of an axisymmetrical aspherical surface T1m1, and the curvature radius on the optical axis OA1 is R1. In a back surface T2m1 (a surface on the side opposite to the axisymmetrical aspherical surface T1m1), an inclined portion V1 is formed. The normal nV1 to the inclined portion V1 is inclined at a minute angle with respect to the optical axis (the axis of symmetry) OA1 of the axisymmetrical aspherical surface. That is, the surface on the side opposite to the axisymmetrical aspherical surface is inclined at the axis of symmetry of the axisymmetrical aspherical surface with respect to the axis of symmetry of the axisymmetrical aspherical surface. In addition, the opposite surface forms a plane in a part including a point at the intersection with the axis of symmetry of the axisymmetrical aspherical surface. In the aspherical surface shape measurement, incident light S1OA1 on the optical axis OA1 is deflected by the inclined portion V1, and therefore the reflected light RS2OA1 is prevented from returning to the optical axis OA1. Therefore, the surface shape of the axisymmetrical aspherical surface T1m1 can be measured with a high degree of accuracy or precision.

When an inclined portion V1 is formed in the back surface T2m1, reflection at edges C1 can generate unexpected ghost in the measurement with an aspherical surface shape measuring device. Therefore, in this embodiment, the edges C1 of the inclined portion V1 are rounded. However, in the aspherical surface shape measurement, the optical axis OA of the lens TS and the optical axis OA1 of the axisymmetrical aspherical surface T1m1 to be inspected are positioned so as to correspond with each other.

### Fourth Embodiment

In the second embodiment, the entire back surface of the convex mirror Tm2 (light-transmitting mirror substrate) is inclined. However, in manufacturing a mirror, it can be difficult to incline the back surface T2m2 sufficiently to deflect the reflected light RS2OA2. In the measurement with an aspherical surface shape measuring device, the reflection by the back surface T2m2 on the optical axis OA2 of the axisymmetrical aspherical surface T1m2 is particularly problematical. In a fourth embodiment, a portion V1 of the back surface T2m2 of the convex mirror Tm2 around the intersection with the optical axis OA2 is inclined.

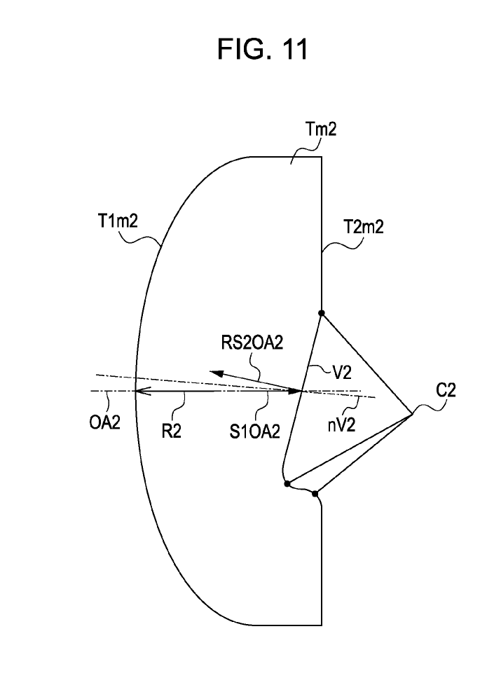

FIG. 11 shows the shape of a convex mirror Tm2 used in an exposure apparatus. OA2 denotes the optical axis of an axisymmetrical aspherical surface T1m2, and the curvature radius on the optical axis OA2 is R2. In a back surface T2m2 (a surface on the side opposite to the axisymmetrical aspherical surface T1m2), an inclined portion V2 is formed. The normal nV2 to the inclined portion V2 is inclined at a minute angle with respect to the optical axis (the axis of symmetry) OA2 of the axisymmetrical aspherical surface. That is, the surface on the side opposite to the axisymmetrical aspherical surface is inclined at the axis of symmetry of the axisymmetrical aspherical surface with respect to the axis of symmetry of the axisymmetrical aspherical surface. In addition, the opposite surface forms a plane in a part including a point at the intersection with the axis of symmetry of the axisymmetrical aspherical surface. In the aspherical surface shape measurement, incident light S1OA2 on the optical axis OA2 is deflected by the inclined portion V2, and therefore the reflected light RS2OA2 is prevented from returning to the optical axis OA2. Therefore, the surface shape of the axisymmetrical aspherical surface T1m2 can be measured with a high degree of accuracy or precision.

When an inclined portion V2 is formed in the back surface T2m2, reflection at edges C2 can generate unexpected ghost in the measurement with an aspherical surface shape measuring device. Therefore, in this embodiment, the edges C2 of the inclined portion V2 are rounded. However, in the aspherical surface shape measurement, the optical axis OA of the lens TS and the optical axis OA2 of the axisymmetrical aspherical surface T1m2 to be inspected are positioned so as to correspond with each other.

### Fifth Embodiment

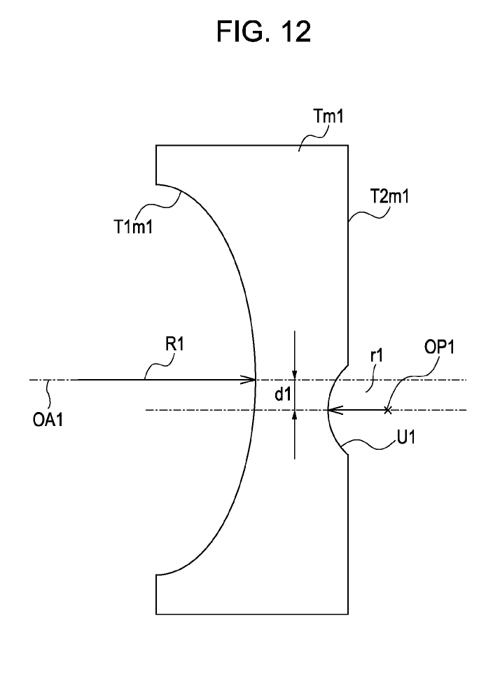

In the first and third embodiments, the back surface T2m1 of the concave mirror Tm1 is inclined, and thereby the reflection RS2OA1 of the incident light S1OA1 on the optical axis OA1 is deflected and prevented from returning to the optical axis OA1. In a fifth embodiment, as shown in FIG. 12, a concave portion U1 is formed, and thereby the reflected light RS2OA1 is deflected, diverged, and prevented from returning to the optical axis OA1. The concave portion U1 is desirably an axisymmetrical surface (for example, a spherical surface) in terms of processing. When the concave portion U1 is an axisymmetrical surface, it is desirable that the concave portion U1 intersect with the axis of symmetry of the axisymmetrical aspherical surface, and the center of curvature of the axisymmetrical surface on the axis of symmetry of the axisymmetrical surface be not on the axis of symmetry of the axisymmetrical aspherical surface. In addition, it is desirable that a curvature radius R of the axisymmetrical aspherical surface on the axis of symmetry, a curvature radius r of the axisymmetrical surface corresponding to the center of curvature, and a distance d between the center of curvature and the axis of symmetry of the axisymmetrical aspherical surface satisfy the following relational expression:

0<d<r<R.

FIG. 12 shows the shape of a concave mirror Tm1 (a light-transmitting mirror substrate) used in an exposure apparatus. OA1 denotes the optical axis (the axis of symmetry) of an axisymmetrical aspherical surface T1m1, and the curvature radius on the optical axis OA1 is R1. In a back surface T2m1 (a surface on the side opposite to the axisymmetrical aspherical surface T1m1), a concave portion U1 is formed. The curvature radius of the concave portion U1 (a spherical surface in this embodiment) is r1. The center of curvature OP1 of the concave portion U1 is a distance d1 away from the optical axis OA1 of the axisymmetrical aspherical surface T1m1. That is, the surface on the side opposite to the axisymmetrical aspherical surface is inclined at the axis of symmetry of the axisymmetrical aspherical surface with respect to the axis of symmetry of the axisymmetrical aspherical surface, and has a shape that diverges reflected light. It is desirable that a curvature radius R1 of the surface T1m1 on the optical axis OA1, a curvature radius r1 of the concave portion U1, and a distance d1 between the optical axis OA1 and the center of curvature OP1 satisfy the following relational expression:

0<d1<r1<R1 (Expression 1)

The values of the distance d1 and the curvature radius r1 differ depending on the curvature radius R1 and the specifications of the aspherical surface shape measuring device. For example, d1 is about 1 mm to 10 mm, and r1 is about 30 mm to 300 mm.

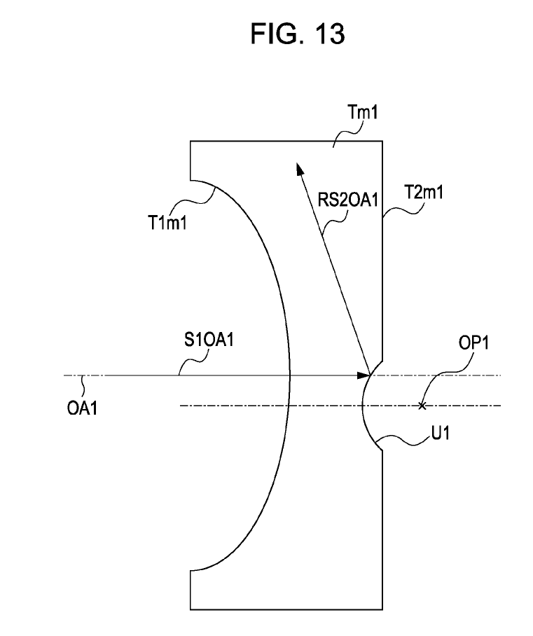

As shown in FIG. 13, in the aspherical surface shape measurement, incident light S1OA1 on the optical axis OA1 is diverged by the concave portion U1 formed in the surface T2m1 on the side opposite to the axisymmetrical aspherical surface T1m1, and therefore reflected light RS2OA1 is prevented from returning to the optical axis OA1. Therefore, the surface shape of the axisymmetrical aspherical surface T1m1 can be measured with a high degree of accuracy or precision. However, in the surface shape measurement, the optical axis OA of the lens TS and the optical axis OA1 of the axisymmetrical aspherical surface T1m1 to be inspected are positioned so as to correspond with each other.

### Sixth Embodiment

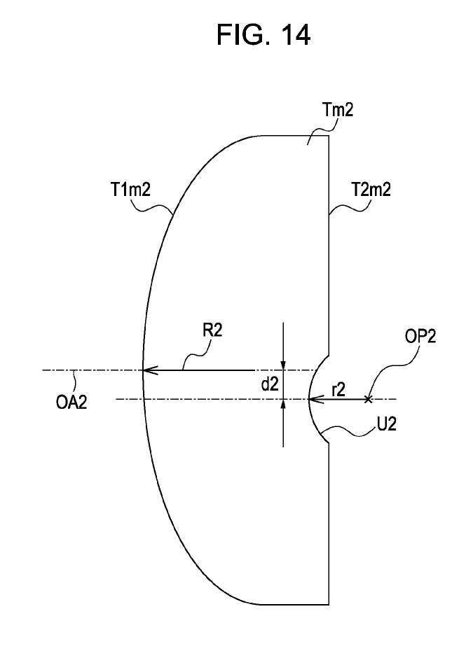

In the second and fourth embodiments, the back surface T2m2 of the convex mirror Tm2 is inclined, and thereby the reflection RS2OA2 of the incident light S1OA2 on the optical axis OA2 is deflected and prevented from returning to the optical axis OA2. In a sixth embodiment, as shown in FIG. 14, a concave portion U2 is formed, and thereby the reflected light RS2OA2 is deflected, diverged, and prevented from returning to the optical axis OA2. The concave portion U2 is desirably an axisymmetrical surface (for example, a spherical surface) in terms of processing. When the concave portion U2 is an axisymmetrical surface, it is desirable that the concave portion U2 intersect with the axis of symmetry of the axisymmetrical aspherical surface, and the center of curvature of the axisymmetrical surface on the axis of symmetry of the axisymmetrical surface be not on the axis of symmetry of the axisymmetrical aspherical surface. In addition, it is preferable that a curvature radius R of the axisymmetrical aspherical surface on the axis of symmetry, a curvature radius r of the axisymmetrical surface corresponding to the center of curvature, and a distance d between the center of curvature and the axis of symmetry of the axisymmetrical aspherical surface satisfy the following relational expression:

0<d<r<R.

FIG. 14 shows the shape of a convex mirror Tm2 (a light-transmitting mirror substrate) used in an exposure apparatus. OA2 denotes the optical axis (the axis of symmetry) of an axisymmetrical aspherical surface T1m2, and the curvature radius on the optical axis OA2 is R2. In a back surface T2m2 (a surface on the side opposite to the axisymmetrical aspherical surface T1m2), a concave portion U2 is formed. The curvature radius of the concave portion U2 is r2. The center of curvature OP2 of the concave portion U2 is a distance d2 away from the optical axis OA2 of the axisymmetrical aspherical surface T1m2. That is, the surface on the side opposite to the axisymmetrical aspherical surface is inclined at the axis of symmetry of the axisymmetrical aspherical surface with respect to the axis of symmetry of the axisymmetrical aspherical surface, and has a shape that diverges reflected light. It is desirable that a curvature radius R2 of the surface T1m2 on the optical axis OA2, a curvature radius r2 of the concave portion U2, and a distance d2 between the optical axis OA2 and the center of curvature OP2 satisfy the following relational expression:

0<d2<r2<R2 (Expression 2)

The values of the distance d2 and the curvature radius r2 differ depending on the curvature radius R2 and the specifications of the aspherical surface shape measuring device. For example, d2 is about 1 mm to 10 mm, and r2 is about 30 mm to 300 mm.

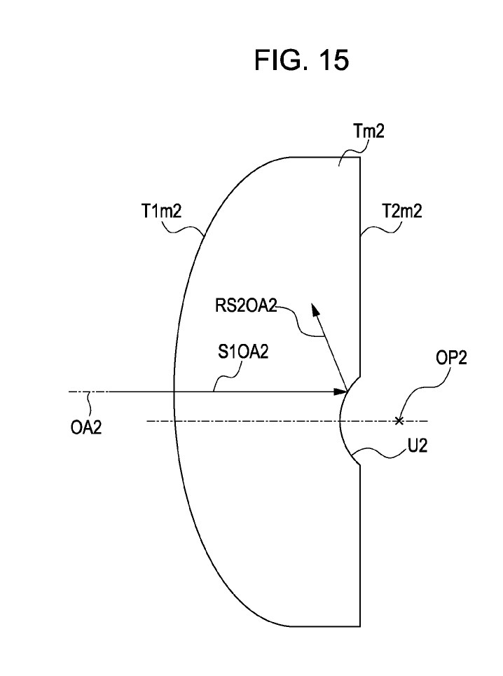

As shown in FIG. 15, in the aspherical surface shape measurement, incident light S1OA2 on the optical axis OA2 is diverged by the concave portion U2 formed in the surface T2m2 on the side opposite to the axisymmetrical aspherical surface T1m2, and therefore reflected light RS2OA2 is prevented from returning to the optical axis OA2. Therefore, the surface shape of the axisymmetrical aspherical surface T1m2 can be measured with a high degree of accuracy or precision. However, in the surface shape measurement, the optical axis OA of the lens TS and the optical axis OA2 of the axisymmetrical aspherical surface T1m2 to be inspected are positioned so as to correspond with each other.

### Seventh Embodiment

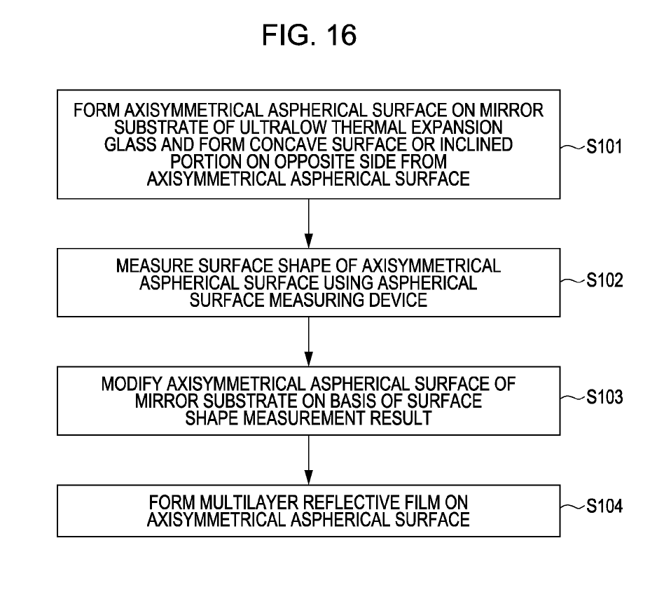

Next, a mirror manufacturing method will be described with reference to FIG. 16.

First, in the step S101, an axisymmetrical aspherical surface is formed on a mirror substrate, and a concave portion or an inclined portion is formed in a surface on the side opposite to the axisymmetrical aspherical surface. The mirror substrate is made of ultralow thermal expansion glass. Next, in the step S102, the surface shape of the axisymmetrical aspherical surface is measured using an aspherical surface shape measuring device. Not only a Fizeau interferometer but also another known measuring device capable of measuring a surface shape, such as a Twyman-Green interferometer, can be used as the aspherical surface shape measuring device. In the step S103, the axisymmetrical aspherical surface is modified on the basis of the result of the surface shape measurement in the step S102. The shape of the axisymmetrical aspherical surface is modified so as to reduce the difference between the measured shape and a desired shape. In the step S104, a reflective film is formed on the axisymmetrical aspherical surface. The reflective film is, for example, a molybdenum-silicon multilayer film or a molybdenum-beryllium multilayer film.

In this way, a mirror for an exposure apparatus is manufactured.

### Eighth Embodiment

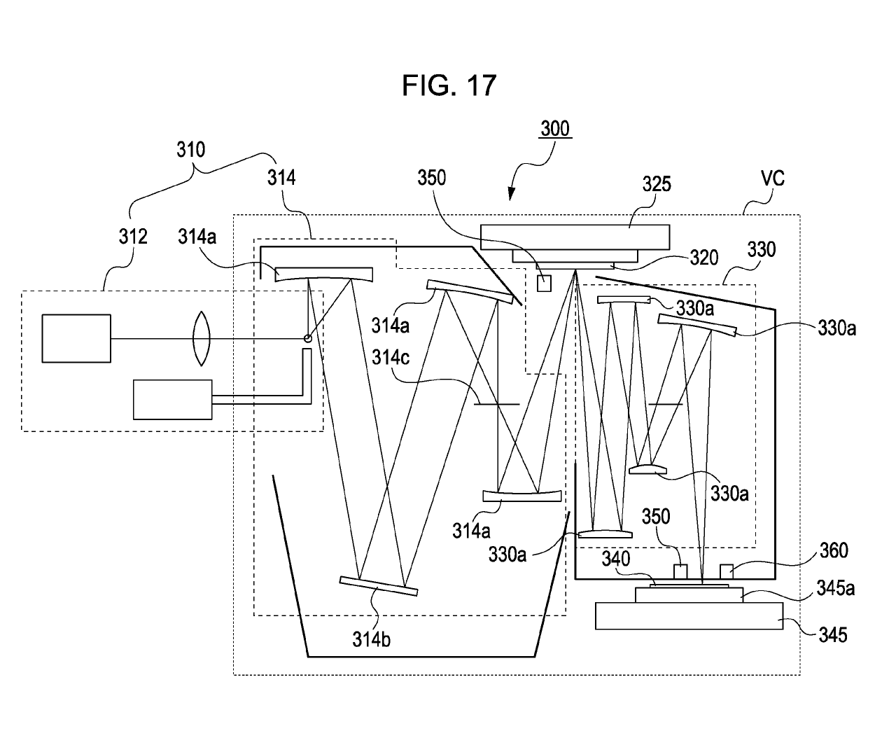

Next, with reference to FIG. 17, a description will be given of an example of a projection exposure apparatus 300 to which the mirrors shown in the first and second embodiments are applicable.

The exposure apparatus 300 of this embodiment uses EUV light (extreme ultraviolet light, for example, with a wavelength of 13.5 nm) as illumination light for exposure, and exposes a circuit pattern formed on a mask 320 onto an object 340 to be processed, for example, in a step-and-scan manner or step-and-repeat manner. Such an exposure apparatus is suitable for a submicron or subquartermicron lithography process. This embodiment will be described by taking a step-and-scan exposure apparatus (also referred to as “scanner”) as an example. The “step-and-scan manner,” as used herein, is an exposure method in which a wafer is continuously scanned relative to a mask to expose a mask pattern onto the wafer, and after a shot of exposure, the wafer is step-moved to the next exposure area. The “step-and-repeat manner” is an exposure method in which, after each block exposure of a wafer, the wafer is step-moved to the exposure area of the next shot.

In FIG. 17, the exposure apparatus 300 includes an illumination device 310 that illuminates the mask 320 with light from a light source, a mask stage 325 on which the mask 320 is placed, and a projection optical system 330 that leads light from the mask 320 to the body 340 to be processed. The exposure apparatus 300 further includes a wafer stage 345 on which the body 340 to be processed is placed, an alignment detection mechanism 350, and a focus position detection mechanism 360.

In FIG. 17, the number of reflecting surfaces (mirrors) of the reflective reduction projection optical system between the mask and the body to be processed (wafer) is four. However, this is for simplification of the figure. The actual number of reflecting surfaces is six or more.

EUV light has low atmospheric transmittance, and it reacts with residual gas, such as polymer organic gas, and generates contaminants. Therefore, as shown in FIG. 17, at least the optical path of EUV light (that is, the entire optical system) is in a vacuum atmosphere VC.

The illumination device 310 illuminates the mask 320 with circular arc-shaped EUV light (for example, with a wavelength of 13.4 nm) corresponding to a circular arc-shaped field of the projection optical system 330. The illumination device 310 includes an EUV light source 312 and an illumination optical system 314.

For example, a laser plasma light source is used as the EUV light source 312. A laser plasma light source irradiates a target material in a vacuum container with highly intense pulse laser light, thereby generating high-temperature plasma. The plasma emits EUV light, for example, with a wavelength of about 13 nm. The EUV light is used for exposure. For example, a metal film, a gas jet, or a droplet is used as a target material. To increase the average intensity of the emitted EUV light, the repetitive frequency of the pulse laser is desirably high. Usually, the repetitive frequency is several kHz.

The illumination optical system 314 includes condenser mirrors 314a and an optical integrator 314b. The condenser mirrors 314a serve to condense EUV light that is emitted approximately isotropically from the laser plasma. The optical integrator 314b serves to uniformly illuminate the mask 320 with a predetermined numerical aperture. The illumination optical system 314 is provided with an aperture 314c at a position conjugate with the mask 320 so as to restrict the illumination area of the mask 320 to an arc shape. A cooling device may be provided that cools optical members constituting the illumination optical system 314, that is, the condenser mirrors 314a and the optical integrator 314b. By cooling the condenser mirrors 314a and the optical integrator 314b, deformation due to thermal expansion is prevented, and excellent optical performance can be obtained.

The mask 320 is a reflective mask and has a circuit pattern (or an image) to be transferred formed thereon. The mask 320 is supported and driven by the mask stage 325. The diffracted light emitted from the mask 320 is reflected by the projection optical system 330 and is projected onto the body 340 to be processed. The mask 320 and the body 340 to be processed are arranged in an optically conjugate relationship. Since the exposure apparatus 300 is a step-and-scan exposure apparatus, the mask 320 and the body 340 to be processed are scanned, and thereby the pattern of the mask 320 is reduction-projected onto the body 340 to be processed.

The mask stage 325 supports the mask 320 and is moved by a moving mechanism (not shown). The mask stage 325 may have any structure. The moving mechanism (not shown) includes, for example, a linear motor and can move the mask 320 by driving the mask stage 325 at least in the X-axis direction. The exposure apparatus 300 synchronously scans the mask 320 and the body 340 to be processed.

The projection optical system 330 uses a plurality of mirrors (multilayer film mirrors) 330a to reduction-project the pattern on the mask 320 onto the image plane, that is, the body 340 to be processed. To achieve a wide exposure area with the smallest possible number of mirrors, the mask 320 and the body 340 to be processed are simultaneously scanned and a wide area is transferred using only a thin circular arc-shaped area (ring field) a certain distance away from the optical axis.

The mirrors 330a that are optical elements constituting the projection optical system 330 may be cooled with a cooling device. By cooling the mirrors 330a, deformation due to thermal expansion is prevented, and excellent optical performance can be obtained.

The body 340 to be processed is a wafer in this embodiment. However, examples of the body 340 to be processed include a liquid crystal substrate and other bodies to be processed. Photoresist is applied to the body 340 to be processed.

The wafer stage 345 holds the body 340 to be processed with a wafer chuck 345a. The wafer stage 345 moves the body 340 to be processed in XYZ-axis directions, for example, using a linear motor. The mask 320 and the body 340 to be processed are scanned synchronously. The positions of the mask stage 325 and the wafer stage 345 are monitored, for example, by a laser interferometer, and the mask stage 325 and the wafer stage 345 are driven at a constant speed ratio.

The alignment detection mechanism 350 measures the positional relationship between the mask 320 and the optical axis of the projection optical system 330 and the positional relationship between the body 340 to be processed and the optical axis of the projection optical system 330, and sets the positions and angles of the mask stage 325 and the wafer stage 345 so that an image of the mask 320 can be projected at a predetermined position on the body 340 to be processed.

The focus position detection mechanism 360 measures the position of the surface of the body 340 to be processed and controls the positions and angles of the wafer stage 345, thereby keeping the surface of the body 340 to be processed at the position of the image plane of the projection optical system 330 during exposure.

During exposure, the EUV light emitted from the illumination device 310 illuminates the mask 320, and the image of the pattern on the mask 320 is formed onto the body 340 to be processed. In this embodiment, the image plane is an arc-shaped (or ring-shaped) image plane. By scanning the mask 320 and the body 340 to be processed at a speed ratio corresponding to the reduction ratio, the pattern on the mask 320 is transferred to the body 340 to be processed.

In the above-described example, mirrors according to the present invention are applied to an exposure apparatus that uses EUV light as exposure light. However, the mirrors can also be applied to an exposure apparatus that uses exposure light other than EUV light, such as ArF excimer laser light or F2 laser light.

### Embodiment of Device Manufacturing Method

Next, a description will be given of an embodiment of the present invention, a method for manufacturing devices (semiconductor devices, liquid crystal display devices). In the method, an exposure apparatus to which the present invention is applied can be used.

Semiconductor devices are manufactured through a front-end process in which integrated circuits are made on a wafer (semiconductor substrate), and a back-end process in which integrated circuit chips on the wafer made in the front-end process are completed as products. The front-end process includes a step of exposing the wafer on which photoresist is applied, using the above-described exposure apparatus, and a step of developing the exposed wafer. The back-end process can include an assembly step (dicing, bonding) and a packaging step (encapsulation). Liquid crystal display devices are manufactured through a step of forming transparent electrodes. The step of forming transparent electrodes can include a substep of applying photoresist to a glass substrate on which a transparent electroconductive film is deposited, a substep of exposing the glass substrate to which photoresist is applied, using the above-described exposure apparatus, and a substep of developing the exposed glass substrate.

The device manufacturing method of this embodiment is more advantageous than conventional methods in at least one of the performance, productivity, quality, and production cost of devices.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-330367 filed Dec. 25, 2008, which is hereby incorporated by reference herein in its entirety.

What is claimed is:

1. A light-transmitting mirror substrate comprising an axisymmetrical aspherical surface, wherein
a surface of the mirror substrate on a side opposite to the axisymmetrical aspherical surface is inclined with respect to an axis of symmetry of the axisymmetrical aspherical surface.

2. A substrate according to claim 1, wherein
the surface opposite to the axisymmetrical aspherical surface includes a concave portion, and
the concave portion includes an axisymmetrical surface that intersects with the axis of symmetry of the axisymmetrical aspherical surface, and a center of curvature of the axisymmetrical surface on an axis of symmetry of the axisymmetrical surface is disposed off the axis of symmetry of the axisymmetrical aspherical surface.

3. A substrate according to claim 2, wherein the axisymmetrical surface is a spherical surface.

4. A substrate according to claim 2, wherein a curvature radius R of the axisymmetrical aspherical surface on the axis of symmetry thereof, a curvature radius r of the axisymmetrical surface corresponding to the center of curvature thereof, and a distance d between the center of curvature and the axis of symmetry of the axisymmetrical aspherical surface satisfy a following relational expression:
0<d<r<R.

5. A substrate according to claim 1, wherein the surface opposite to the axisymmetrical aspherical surface includes a plane that has a point at which the axis of symmetry of the axisymmetrical aspherical surface and the surface opposite to the axisymmetrical aspherical surface intersect each other.

6. A mirror comprising:
a mirror substrate defined in claim 1; and
a reflective film formed on the axisymmetrical aspherical surface.

7. A mirror according to claim 6, wherein the reflective film is configured to reflect extreme ultraviolet light.

8. An exposure apparatus for exposing an object to light, the apparatus comprising:
a mirror defined in claim 6,
wherein the apparatus is configured to expose the object to light via the mirror.

9. A method of manufacturing a device, the method comprising:
exposing a substrate to light using an exposure apparatus defined in claim 8;
developing the exposed substrate; and
processing the developed substrate to manufacture the device.

10. A method of manufacturing a mirror, the method comprising:
forming an axisymmetrical aspherical surface on a light-transmitting substrate;
forming a surface inclined with respect to an axis of symmetry of the axisymmetrical aspherical surface as a surface of the substrate on a side opposite to the axisymmetrical aspherical surface;
measuring a shape of the axisymmetrical aspherical surface with an interferometer;
modifying the shape of the axisymmetrical aspherical surface to reduce a difference between the measured shape and a target shape; and
forming a reflective film on the modified axisymmetrical aspherical surface.

11. A substrate according to claim 1, wherein
a normal to the surface of the mirror substrate on the side opposite to the axisymmetrical aspherical surface, the normal extending from a point of intersection of the surface of the mirror substrate on the side opposite to the axisymmetrical aspherical surface and the axis of symmetry of the axisymmetrical aspherical surface, is inclined with respect to the axis of symmetry of the axisymmetrical aspherical surface.

12. A method according to claim 10, wherein
a normal to the surface of the substrate on the side opposite to the axisymmetrical aspherical surface, the normal extending from a point of intersection of the surface of the substrate on the side opposite to the axisymmetrical aspherical surface and the axis of symmetry of the axisymmetrical aspherical surface, is inclined with respect to the axis of symmetry of the axisymmetrical aspherical surface.
